(19) United States
(12) Patent Application Publication
(10) Pub. No.: US 2026/0357793 A1
(43) Pub. Date: Nov. 12, 2026

(54) ACTUATOR ASSEMBLY

(71) Applicant: Cambridge Mechatronics Limited, Cambridge, Cambridgeshire (GB)

(72) Inventors: Robin Eddington, Cambridge, Cambridgeshire (GB); Robert Langhorne, Cambridge, Cambridgeshire (GB); Andrew Benjamin Simpson Brown, Cambridge, Cambridgeshire (GB)

(21) Appl. No.: 19/515,503

(22) PCT Filed: Sep. 6, 2024
(86) PCT No.: PCT/GB2024/052337

§ 371 Date: Mar. 2, 2026

(30) Foreign Application Priority Data
Sep. 6, 2023 (GB) 2313614.6

(51) Int. Cl. F03G 7/06

(52) U.S. Cl. CPC F03G 7/0614

(57) ABSTRACT

An actuator assembly comprises: a first part, a second part that is movable relative to the first part, a bearing arrangement, first and second SMA (shape memory alloy) actuating units configured to apply respective first and second forces to a first side of the second part, and third and fourth SMA actuating units configured to apply respective third and fourth forces to a second side of the second part. The first and second forces are capable of rotating the second part relative to the first part in a first sense about a first axis, the third and fourth forces are capable of rotating the second part relative to the first part in a second, opposite sense about the first axis, each of the first and third forces has a component in a first direction along a second axis, and each of the second and fourth forces has a component in a second, opposite direction along the second axis.

### FIELD

The present application relates to an actuator assembly comprising a plurality of SMA (shape memory alloy) actuating units suitable for e.g. moving an optical component (such as a camera module comprising an image sensor and/or a lens assembly) relative to a support structure.

### BACKGROUND

The present application relates to an SMA actuator. SMA actuators have various applications and, for example, can be used to provide optical image stabilisation (OIS) in compact cameras for smartphones and other electronic devices. For instance, WO 2011/104518 A1 describes an actuator with eight SMA wires which is able to rotate a camera module (including a set of lenses and an image sensor) about three perpendicular axes so as to provide OIS. WO 2021/209770 A1 describes an actuator with e.g. four SMA wires and a bearing arrangement which is able to rotate a camera module about two axes perpendicular to a primary axis.

### SUMMARY

According to a first aspect of the present invention, there is provided an actuator assembly comprising: a first part, with a first primary axis defined with reference to the first part; a second part that is movable relative to the first part, with a second primary axis defined with reference to the second part, a first axis that is perpendicular to the first primary axis and that extends through first and second sides of the second part, and a second axis that is perpendicular to the first primary axis and the first axis; a bearing arrangement that allows the second part to rotate relative to the first part about the first axis and that further allows the second part to move relative to the first part at least partly along the second axis and/or to rotate relative to the first part about the first primary axis; and first and second SMA (shape memory alloy) actuating units configured to apply respective first and second forces to the first side of the second part; and third and fourth SMA actuating units configured to apply respective third and fourth forces to the second side of the second part; wherein the first and second forces are capable of rotating the second part relative to the first part in a first sense about the first axis, the third and fourth forces are capable of rotating the second part relative to the first part in a second, opposite sense about the first axis, each of the first and third forces has a (force) component in a first direction along a second axis, and each of the second and fourth forces has a (force) component in a second, opposite direction along the second axis.

Thus, the actuator assembly is of a type in which the actuating units are configured to rotate the second (movable) part about a rotation axis by applying forces to the side of the second part through which the rotation axis extends. Such a configuration can be advantageous because it enables the forces to be applied at positions relatively close to the rotation axis and hence the amount of rotation per unit actuation to be relatively large.

The first and second forces may each and/or together be capable of rotating the second part relative to the first part in the first sense about the first axis. The third and fourth forces may each and/or together be capable of rotating the second part relative to the first part in the second, opposite sense about the first axis.

Moreover, in this actuator assembly, the actuating units can be actuated so that together they produce a desired amount of rotation about the first axis, while also acting at least partly in opposite directions along the second axis and thus enabling positional control along the second axis. This can be particularly important in actuator assemblies in which the bearing arrangement does not provide positional control along the second axis, for example because the bearing arrangement is configured as described herein to allow rotation of the second part about the primary axis. Without such positional control, the performance of the actuator assembly may be negatively affected. For example, not all of the actuation may be converted into rotation and so the range of useful movement may be reduced. Also, the ability to control the rotation may be impaired or lost if the distances between the first and second forces and the rotation axis (and hence the amount of rotation per unit actuation) are unknown and/or changing.

Optionally, each of the first, second, third and/or fourth forces is substantially parallel to the second axis.

Optionally, each of the first, second, third and/or fourth forces has a (force) component in a first direction (i.e. in the same direction) along the first primary axis.

Optionally, the (force) component(s) in the first direction along the first primary axis load the bearing arrangement (e.g. throughout the range of movement of the second part relative to the first part).

Optionally, the first and second forces are applied at respective first and second points on the first side, and wherein the first and second points have substantially the same position along the second axis as the point at which the first axis crosses the first side.

Optionally, the third and fourth forces are applied at respective third and fourth points on the second side, and wherein the third and fourth points have substantially the same position along the second axis as the point at which the first axis crosses the second side.

Optionally, the points at which the first and second forces are applied to the second part remain equally spaced from the first axis throughout the range of rotational movement of the second part relative to the first part (e.g. the range of rotational movement the second part is configured to be moved within relative the first part by the first, second, third and fourth SMA actuating units).

Optionally, the points at which the third and fourth forces are applied to the second part remain equally spaced from the first axis throughout the range of rotational movement of the second part relative to the first part (e.g. the range of rotational movement the second part is configured to be moved within relative the first part by the first, second, third and fourth SMA actuating units).

Optionally, the distances between the first axis and the points at which the first and second forces are applied to the second part remain substantially constant throughout the range of rotational movement of the second part relative to the first part (e.g. the range of rotational movement the second part is configured to be moved within relative the first part by the first, second, third and fourth SMA actuating units). Thus, the amount of rotation per unit actuation remains substantially constant and so the actuating units can be more effectively controlled.

Optionally, the distances between the first axis and the points at which the third and fourth forces are applied to the second part remain substantially constant throughout the range of rotational movement of the second part relative to the first part (e.g. the range of rotational movement the second part is configured to be moved within relative the first part by the first, second, third and fourth SMA actuating units). Thus, the amount of rotation per unit actuation remains substantially constant and so the actuating units can be more effectively controlled.

The above-mentioned ‘range of rotational movement’ may refer to the range of rotation that the second part is configured to rotate within, relative to the first part, about the first axis and, optionally, about the first primary axis.

Optionally, the bearing arrangement comprises a first bearing element positioned on (i.e. on or near to) the first side of the second part and a second bearing element positioned on (i.e. on or near to) the second side of the second part.

Optionally, each bearing element is a rolling element (e.g. a ball bearing) which interacts with bearing surfaces associated with the first and second parts so as to guide the rotation of the second part relative to the first part about the first axis and to guide the movement of the second part relative to the first part at least partly along the second axis and/or the rotation of the second part relative to the first part about the first primary axis.

Optionally, the SMA actuating units each comprise one or more SMA elements.

Optionally, the actuator assembly comprises only two SMA actuating units (i.e. the first and second SMA actuating units) applying forces to the first side of the second part, and only two SMA actuating units (i.e. the third and fourth SMA actuating units) applying forces to the second side of the second part.

Optionally, the first, second, third and fourth SMA actuating units are configured, on selective actuation, to rotate (e.g. in both senses) the second part relative to the first part about the first primary axis.

Optionally, the first, second, third and fourth SMA actuating units are configured, on selective actuation, to move the second part relative to the first part at least partly along the second axis.

Optionally, the second axis extends through third and fourth sides of the second part; the bearing arrangement allows the second part to rotate relative to the first part about the second axis, and allows the second part to move relative to the first part at least partly along the first axis and/or to rotate relative to the first part about the first primary axis; and the actuator assembly further comprises: fifth and sixth SMA actuating units configured to apply respective fifth and sixth forces to the third side of the second part; and seventh and eighth SMA actuating units configured to apply respective seventh and eighth forces to the fourth side of the second part; wherein the fifth and sixth forces are capable of rotating the second part relative to the first part in a first sense about the second axis, the seventh and eighth forces are capable of rotating the second part relative to the first part in a second, opposite sense about the second axis, each of the fifth and seventh forces has a (force) component in a first direction along a first axis, and each of the sixth and eighth forces has a (force) component in a second, opposite direction along the first axis.

The fifth and sixth forces may each and/or together be capable of rotating the second part relative to the first part in the first sense about the second axis. The seventh and eighth forces may each and/or together be capable of rotating the second part relative to the first part in the second, opposite sense about the second axis.

Optionally, each of the fifth, sixth, seventh and/or eighth forces is substantially parallel to the first axis.

Optionally, each of the fifth, sixth, seventh and/or eighth forces has a (force) component in a first direction (i.e. in the same direction) along the first primary axis. The first direction mentioned above in relation to the first, second, third and/or fourth forces may correspond to this first direction.

Optionally, the (force) component(s) in the first direction along the first primary axis load the bearing arrangement (e.g. throughout the range of movement of the second part relative to the first part).

Optionally, the fifth and sixth forces are applied at respective fifth and sixth points on the third side, and wherein the fifth and sixth points have substantially the same position along the first axis as the point at which the second axis crosses the third side.

Optionally, the seventh and eighth forces are applied at respective seventh and eighth points on the fourth side, and wherein the seventh and eighth points have substantially the same position along the first axis as the point at which the second axis crosses the fourth side.

Optionally, the points at which the fifth and sixth forces are applied to the second part remain equally spaced from the second axis throughout the range of rotational movement of the second part relative to the first part (i.e. the range of rotational movement the second part is configured to be moved within relative to the first part by the SMA actuating units).

Optionally, the points at which the seventh and eighth forces are applied to the second part remain equally spaced from the second axis throughout the range of rotational movement of the second part relative to the first part (i.e. the range of rotational movement the second part is configured to be moved within relative to the first part by the SMA actuating units).

Optionally, the distances between the second axis and the points at which the fifth and sixth forces are applied to the second part remain substantially constant throughout the range of rotational movement of the second part relative to the first part (i.e. the range of rotational movement the second part is configured to be moved within relative the first part by the SMA actuating units). Thus, the amount of rotation per unit actuation remains substantially constant and so the actuating units can be more effectively controlled.

Optionally, the distances between the second axis and the points at which the seventh and eighth forces are applied to the second part remain substantially constant throughout the range of rotational movement of the second part relative to the first part (i.e. the range of rotational movement the second part is configured to be moved within relative the first part by the SMA actuating units). Thus, the amount of rotation per unit actuation remains substantially constant and so the actuating units can be more effectively controlled.

The above-mentioned ‘range of rotational movement’ may refer to the range of rotation that the second part is configured to rotate within, relative to the first part, about the second axis and, optionally, about the first primary axis.

Optionally, the bearing arrangement comprises a third bearing element positioned on (i.e. on or near to) the third side of the second part and a fourth bearing element positioned on (i.e. on or near to) the fourth side of the second part.

Optionally, each third and fourth bearing element is a rolling element (e.g. a ball bearing) which interacts with bearing surfaces associated with the second part and an intermediate part (herein also referred to as a ‘gimbal component’) so as to guide the rotation of the second part relative to the first part about the second axis and to guide the movement of the second part relative to the first part at least partly along the first axis and/or the rotation of the second part relative to the first part about the first primary axis.

Optionally, the SMA actuating units each comprise one or more SMA elements.

Optionally, the actuator assembly comprises only two SMA actuating units (i.e. the fifth and sixth SMA actuating units) applying forces to the third side of the second part, and only two SMA actuating units (i.e. the seventh and eighth SMA actuating units) applying forces to the fourth side of the second part.

Optionally, the fifth, sixth, seventh and eighth SMA actuating units are configured, on selective actuation, to rotate (e.g. in both senses) the second part relative to the first part about the first primary axis.

Optionally, the fifth, sixth, seventh and eighth SMA actuating units are configured, on selective actuation, to move the second part relative to the first part at least partly along the first axis.

Optionally, the actuator assembly comprises: a third part that is movable relative to the second part, with a third axis that is perpendicular to the second primary axis and that extends through third and fourth sides of the third part, and a fourth axis that is perpendicular to the second primary axis and the third axis; a second bearing arrangement that allows the third part to rotate relative to the second part about the third axis and that further allows the third part to move relative to the second part at least partly along the fourth axis and/or to rotate relative to the third part about the second primary axis; and fifth and sixth SMA actuating units configured to apply respective fifth and sixth forces to the third side of the third part; and seventh and eighth SMA actuating units configured to apply respective seventh and eighth forces to the fourth side of the third part; wherein the fifth and sixth forces are capable of rotating the third part relative to the second part in a first sense about the third axis, the seventh and eighth forces are capable of rotating the third part relative to the second part in a second, opposite sense about the third axis, each of the fifth and seventh forces has a (force) component in a first direction along a fourth axis, and each of the sixth and eighth forces has a (force) component in a second, opposite direction along the fourth axis.

The fifth and sixth forces may each and/or together be capable of rotating the third part relative to the second part in the first sense about the third axis. The seventh and eighth forces may each and/or together be capable of rotating the third part relative to the second part in the second, opposite sense about the third axis.

Optionally, each of the fifth, sixth, seventh and/or eighth forces is substantially parallel to the fourth axis.

Optionally, each of the fifth, sixth, seventh and/or eighth forces has a (force) component in a first direction (i.e. in the same direction) along the second primary axis. The first direction along the second primary axis may be co-directional with, or opposite to, the first direction along the first primary axis mentioned above in relation to the first, second, third and/or fourth forces when the first and second primary axis are aligned.

Optionally, the (force) component(s) in the first direction along the second primary axis load the second bearing arrangement.

Optionally, the fifth and sixth forces are applied at respective fifth and sixth points on the third side, and wherein the fifth and sixth points have substantially the same position along the fourth axis as the point at which the third axis crosses the third side.

Optionally, the seventh and eighth forces are applied at respective seventh and eighth points on the fourth side, and wherein the seventh and eighth points have substantially the same position along the fourth axis as the point at which the third axis crosses the fourth side.

Optionally, the points at which the fifth and sixth forces are applied to the third part remain equally spaced from the third axis throughout the range of rotational movement of the third part relative to the second part (i.e. the range of rotational movement the third part is configured to be moved within relative the second part).

Optionally, the points at which the seventh and eighth forces are applied to the third part remain equally spaced from the third axis throughout the range of rotational movement of the third part relative to the second part (i.e. the range of rotational movement the third part is configured to be moved within relative the second part).

Optionally, the distances between the third axis and the points at which the fifth and sixth forces are applied to the third part remain substantially constant throughout the range of rotational movement of the third part relative to the second part (i.e. the range of rotational movement the third part is configured to be moved within relative the second part). Thus, the amount of rotation per unit actuation remains substantially constant and so the actuating units can be more effectively controlled.

Optionally, the distances between the third axis and the points at which the seventh and eighth forces are applied to the third part remain substantially constant throughout the range of rotational movement of the third part relative to the second part (i.e. the range of rotational movement the third part is configured to be moved within relative the second part). Thus, the amount of rotation per unit actuation remains substantially constant and so the actuating units can be more effectively controlled.

The above-mentioned ‘range of rotational movement of the third part’ may refer to the range of rotation that the third part is configured to rotate within, relative to the second part, about the third axis and, optionally, about the second primary axis.

Optionally, the second bearing arrangement comprises a third bearing element positioned on (i.e. on or near to) the third side of the third part and a fourth bearing element positioned on (i.e. on or near to) the fourth side of the third part.

Optionally, each third and fourth bearing element is a rolling element (e.g. a ball bearing) which interacts with bearing surfaces associated with the second and third parts so as to guide the rotation of the third part relative to the second part about the third axis and to guide the movement of the third part relative to the second part at least partly along the fourth axis and/or the rotation of the third part relative to the second part about the second primary axis.

Optionally, the SMA actuating units each comprise one or more SMA elements

Optionally, the actuator assembly comprises only two SMA actuating units (i.e. the fifth and sixth SMA actuating units) applying forces to the third side of the third part, and only two SMA actuating units (i.e. the seventh and eighth SMA actuating units) applying forces to the fourth side of the third part.

Optionally, the fifth, sixth, seventh and eighth SMA actuating units are configured, on selective actuation, to rotate (e.g. in both senses) the third part relative to the second part about the second primary axis.

Optionally, the fifth, sixth, seventh and eighth SMA actuating units are configured, on selective actuation, to move the third part relative to the second part at least partly along the fourth axis.

Optionally, the first and third axes are non-parallel.

Optionally, the first, second, third and fourth sides are arranged in a loop around the first primary axis. The first and second sides may be opposite sides. The third and fourth sides may be opposite sides.

According to another aspect of the present invention, there is provided a method of controlling the actuator assembly mentioned above, the method comprising: actuating the first, second, third and/or fourth actuating units so as to cause the second part to rotate relative to the first part about the first axis, while controlling the position of the second part relative to the first part along the second axis and/or the rotation of the second part relative to the first part about the first primary axis.

Optionally, the method comprises actuating the first, second, third and/or fourth actuating units so as to cause the second part to rotate relative to the first part about the first primary axis.

Optionally, the method comprises actuating the fifth, sixth, seventh and/or eighth actuating units so as to cause the second part to rotate relative to the first part about the second axis, while controlling the position of the second part relative to the first part along the first axis and/or the rotation of the second part relative to the first part about the first primary axis.

Optionally, the method comprises actuating the fifth, sixth, seventh and/or eighth actuating units so as to cause the second part to rotate relative to the first part about the first primary axis.

Optionally, the method comprises actuating the fifth, sixth, seventh and/or eighth actuating units so as to cause the third part to rotate relative to the second part about the third axis, while controlling the position of the third part relative to the second part along the fourth axis and/or the rotation of the third part relative to the second part about the second primary axis.

Optionally, the method comprises actuating the fifth, sixth, seventh and/or eighth actuating units so as to cause the third part to rotate relative to the second part about the second primary axis.

According to another aspect of the present invention, there is provided an actuator assembly comprising: a first part, with a first primary axis defined with reference to the first part; a second part that is movable relative to the first part, with a second primary axis defined with reference to the second part; a first pair of SMA actuating units (i.e. the first and second SMA actuating units) configured to apply a torque to a first side of the second part to drive rotation of the second part relative to the first part in a first sense about a first tilt axis (also referred to as ‘first axis’ herein), wherein the first tilt axis is perpendicular to the first primary axis; a second pair of SMA actuating units (i.e. the third and fourth SMA actuating units) configured to apply a torque to a second side of the second part to drive rotation of the second part relative to the first part in a second, opposite sense about the first tilt axis; wherein the first and second sides are opposite sides through which the first tilt axis extends; wherein only the first pair of SMA actuating units are configured to apply a torque to the first side for rotating the second part relative to the first part about the first tilt axis, and only the second pair of actuating units are configured to apply a torque to the second side for rotating the second part relative to the first part about the first tilt axis; wherein each SMA actuating unit is configured to apply a force to the second part in a direction perpendicular to the first primary axis, or configured to apply a force with a force component in a first direction (i.e. in the same direction) parallel to the first primary axis (e.g. throughout the range of movement of the second part relative to the first part).

Optionally, the actuator assembly comprises a first bearing arrangement configured to allow rotation of the second part relative to the first part about the first tilt axis, and to constrain rotation of the second part relative to the first part about an axis (e.g. the second tilt axis mentioned hereinafter, or an axis parallel to said second tilt axis) which is non-parallel to the first tilt axis and is perpendicular to the first primary axis.

Optionally, the actuator assembly comprises: a third part movable relative to the second part; a third plurality of SMA actuating units (e.g. the fifth and sixth SMA actuating units) each configured to apply a torque to a third side of the third part to drive rotation of the third part relative to the second part about a second tilt axis (also referred to as ‘third axis’ herein) in a first sense, wherein the second tilt axis is non-parallel to the first tilt axis and is perpendicular to the second primary axis; a fourth plurality of SMA actuating units (e.g. the seventh and eighth SMA actuating units) each configured to apply a torque to a fourth side of the third part to drive rotation of the third part relative to the second part about the second tilt axis in a second, opposite sense; and wherein the third and fourth sides are opposite sides through which the second tilt axis extends.

Optionally, the actuator assembly comprises a second bearing arrangement configured to allow rotation of the third part relative to the second part about the second tilt axis, and to constrain rotation of the third part relative to the second part about the first tilt axis or an axis parallel to the first tilt axis.

Optionally, only the third plurality of SMA actuating units are configured to apply a torque to the third part for rotating the third part relative to the second part about the second tilt axis; and only the fourth plurality of SMA actuating units are configured to apply a torque to the third part for rotating the third part relative to the second part about the second tilt axis.

Optionally, each SMA actuating unit of the third and fourth plurality of SMA actuating units is configured to apply a force to the third part in a direction perpendicular to the second primary axis, or configured to apply a force to the third part with a force component in a first direction (i.e. in the same direction) parallel to the second primary axis (e.g. throughout the range of movement of the third part relative to the second part).

Optionally, the actuator assembly comprises: a third plurality of SMA actuating units (e.g. the fifth and sixth SMA actuating units) each configured to apply a torque to a third side of the second part to drive rotation of the second part relative to the first part about a second tilt axis (also referred to as ‘second axis’ herein) in a first sense, wherein the second tilt axis is non-parallel to the first tilt axis and is perpendicular to the first primary axis; a fourth plurality of SMA actuating units (e.g. the seventh and eighth SMA actuating units) each configured to apply a torque to a fourth side of the second part to drive rotation of the second part relative to the first part about the second tilt axis in a second, opposite sense; and wherein the third and fourth sides are opposite sides through which the second tilt axis extends.

Optionally, the actuator assembly comprises a bearing arrangement configured to allow rotation of the second part relative to the first part about the first and second tilt axes.

Optionally, only the third plurality of SMA actuating units are configured to apply a torque to the second part for rotating the second part relative to the first part about the second tilt axis; and only the fourth plurality of SMA actuating units are configured to apply a torque to the second part for rotating the second part relative to the first part about the second tilt axis.

Optionally, each SMA actuating unit of the third and fourth plurality of SMA actuating units is configured to apply a force to the second part in a direction perpendicular to the first primary axis, or configured to apply a force to the second part with a force component in a first direction parallel to the first primary axis (e.g. throughout the range of movement of the second part relative to the first part).

Optionally, the third plurality of SMA actuating units comprises a total of two SMA actuating units and the fourth plurality of SMA actuating units comprises a total of two SMA actuating units.

Optionally, the forces applied by the first pair of SMA actuating units are above and below the first tilt axis as viewed along the first tilt axis.

Optionally, the forces applied by the second pair of SMA actuating units are above and below the first tilt axis as viewed along the first tilt axis.

Optionally, the axes in which the forces applied by the first pair of SMA actuating units lie are non-intersecting (do not cross one another) within the footprint of the actuator assembly as viewed along the first tilt axis.

Optionally, the axes in which the forces applied by the second pair of SMA actuating units lie are non-intersecting (do not cross one another) within the footprint of the actuator assembly as viewed along the first tilt axis.

Optionally, the SMA elements comprising part of the first pair of SMA actuating units are non-intersecting (do not cross one another) as viewed along the first tilt axis.

Optionally, the SMA elements comprising part of the second pair of SMA actuating units are non-intersecting (do not cross one another) as viewed along the first tilt axis.

Optionally, the forces applied by the third plurality of SMA actuating units are above and below the second tilt axis as viewed along the second tilt axis.

Optionally, the forces applied by the fourth plurality of SMA actuating units are above and below the second tilt axis as viewed along the second tilt axes.

Optionally, the axes in which the forces applied by the third plurality of SMA actuating units lie are non-intersecting (do not cross one another) within the footprint of the actuator assembly as viewed along the second tilt axis.

Optionally, the axes in which the forces applied by the fourth plurality of SMA actuating units lie are non-intersecting (do not cross one another) within the footprint of the actuator assembly as viewed along the second tilt axis.

Optionally, the SMA elements comprising part of the third plurality of SMA actuating units are non-intersecting (do not cross one another) as viewed along the second tilt axis.

Optionally, the SMA elements comprising part of the fourth plurality of SMA actuating units are non-intersecting (do not cross one another) as viewed along the second tilt axis.

### BRIEF DESCRIPTION OF THE DRAWINGS

Certain embodiments of the present invention will now be described, by way of example only, with reference to the accompanying drawings in which:

FIG. 1 is a schematic perspective view of an actuator assembly;

FIG. 2 is a schematic perspective view of an actuator assembly;

FIG. 3 is a schematic side view of an actuator assembly;

FIG. 4 is a schematic side view of an actuator assembly;

FIG. 5 is a schematic perspective view of an actuator assembly;

FIG. 6 is a schematic cross-sectional side view of an actuator assembly.

### DETAILED DESCRIPTION

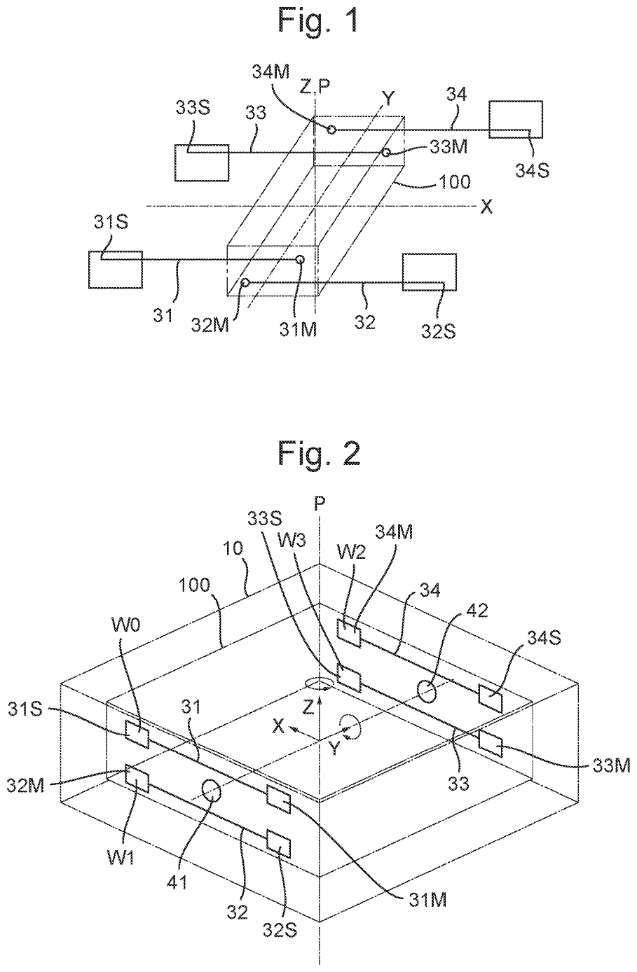

### FIGS. 1 to 4

As illustrated in e.g. FIGS. 1 to 4, according to a first aspect of the present invention, there is provided an actuator assembly comprising: a first part 10, with a first primary axis Z defined with reference to the first part 10; a second part 100 that is movable relative to the first part 10, with a second primary axis P defined with reference to the second part 100, a first axis Y that is perpendicular to the first primary axis Z and that extends through first and second sides of the second part 100, and a second axis X that is perpendicular to the first primary axis Z and the first axis Y; a bearing arrangement 41, 42 that allows the second part 100 to rotate relative to the first part 10 about the first axis Y and that further allows the second part 100 to move relative to the first part 10 at least partly along the second axis X and/or to rotate relative to the first part 10 about the first primary axis Z; and first and second SMA (shape memory alloy) actuating units 31, 32 configured to apply respective first and second forces to the first side of the second part 100; and third and fourth SMA actuating units 33, 34 configured to apply respective third and fourth forces to the second side of the second part 100; wherein the first and second forces are capable of rotating the second part 100 relative to the first part 10 in a first sense about the first axis Y, the third and fourth forces are capable of rotating the second part 100 relative to the first part 10 in a second, opposite sense about the first axis Y, each of the first and third forces has a (force) component in a first direction along a second axis X, and each of the second and fourth forces has a (force) component in a second, opposite direction along the second axis X.

The first and second forces may each and/or together be capable of rotating the second part 100 relative to the first part 10 in the first sense about the first axis Y. The third and fourth forces may each and/or together be capable of rotating the second part 100 relative to the first part 10 in the second, opposite sense about the first axis Y.

As illustrated in FIGS. 1 to 4, each of the first, second, third and fourth SMA actuating units 31, 32, 33, 34 may comprise an SMA element 31, 32, 33, 34 (configured to contract when actuated, i.e. heated by passing an electric current through the SMA element) which is fixed to the first part 10 at a first end 31S, 32S, 33S, 34S and fixed to the second part 100 at a second end 31M, 32M, 33M, 34M.

Optionally, as illustrated in FIGS. 1 to 4, each of the first, second, third and/or fourth forces is substantially parallel to the second axis X.

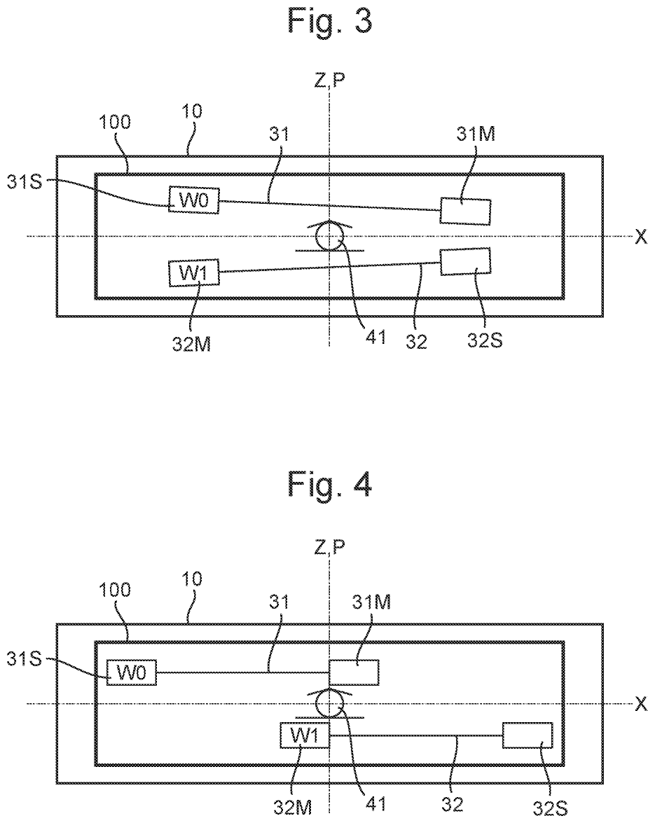

Optionally, as illustrated in FIG. 3, each of the first, second, third and/or fourth forces has a (force) component in a first direction (i.e. in the same direction) along the first primary axis Z.

Optionally, as illustrated in FIG. 3, the (force) component(s) in the first direction along the first primary axis Z load the bearing arrangement 41, 42 (e.g. throughout the range of movement of the second part 100 relative to the first part 10).

Optionally, as illustrated in FIG. 4, the first and second forces are applied at respective first and second points on the first side, and the first and second points have substantially the same position along the second axis X as the point at which the first axis Y crosses the first side.

Optionally, the third and fourth forces are applied at respective third and fourth points on the second side, and wherein the third and fourth points have substantially the same position along the second axis X as the point at which the first axis Y crosses the second side.

Optionally, the points at which the first and second forces are applied to the second part 100 remain equally spaced from the first axis Y throughout the range of rotational movement of the second part 100 relative to the first part 10 (e.g. the range of rotational movement the second part 100 is configured to be moved within relative the first part 10 by the first, second, third and fourth SMA actuating units 31-34).

Optionally, the points at which the third and fourth forces are applied to the second part 100 remain equally spaced from the first axis Y throughout the range of rotational movement of the second part 100 relative to the first part 10 (e.g. the range of rotational movement the second part 100 is configured to be moved within relative the first part 10 by the first, second, third and fourth SMA actuating units 31-34).

Optionally, the distances between the first axis Y and the points at which the first and second forces are applied to the second part 100 remain substantially constant throughout the range of rotational movement of the second part 100 relative to the first part 10 (e.g. the range of rotational movement the second part 100 is configured to be moved within relative the first part 10 by the first, second, third and fourth SMA actuating units 31-34). Thus, the amount of rotation per unit actuation remains substantially constant and so the actuating units can be more effectively controlled.

Optionally, the distances between the first axis Y and the points at which the third and fourth forces are applied to the second part 100 remain substantially constant throughout the range of rotational movement of the second part 100 relative to the first part 10 (e.g. the range of rotational movement the second part 100 is configured to be moved within relative the first part 10 by the first, second, third and fourth SMA actuating units 31-34). Thus, the amount of rotation per unit actuation remains substantially constant and so the actuating units can be more effectively controlled.

Optionally, the bearing arrangement 41, 42 comprises a first bearing element 41 positioned on (i.e. on or near to) the first side of the second part 100 and a second bearing element 42 positioned on (i.e. on or near to) the second side of the second part 100.

The above-mentioned ‘range of rotational movement’ may refer to the range of rotation that the second part 100 is configured to rotate within, relative to the first part 10, about the first axis Y and, optionally, about the first primary axis Z.

Optionally, each bearing element 41, 42 is a rolling element (e.g. a ball bearing) which interacts with bearing surfaces associated with the first and second parts 10, 100 so as to guide the rotation of the second part 100 relative to the first part 10 about the first axis Y and to guide the movement of the second part 100 relative to the first part 10 at least partly along the second axis X and/or the rotation of the second part 100 relative to the first part 10 about the first primary axis Z.

Optionally, the SMA actuating units 31-34 each comprise one or more SMA elements 31-34.

Optionally, the actuator assembly comprises only two SMA actuating units (i.e. the first and second SMA actuating units 31, 32) applying forces to the first side of the second part 100, and only two SMA actuating units (i.e. the third and fourth SMA actuating units 33, 34) applying forces to the second side of the second part 100.

Optionally, the first, second, third and fourth SMA actuating units 31-34 are configured, on selective actuation, to rotate (e.g. in both senses) the second part 100 relative to the first part 10 about the first primary axis Z.

Optionally, the first, second, third and fourth SMA actuating units 31-34 are configured, on selective actuation, to move the second part 100 relative to the first part 10 at least partly along the second axis X.

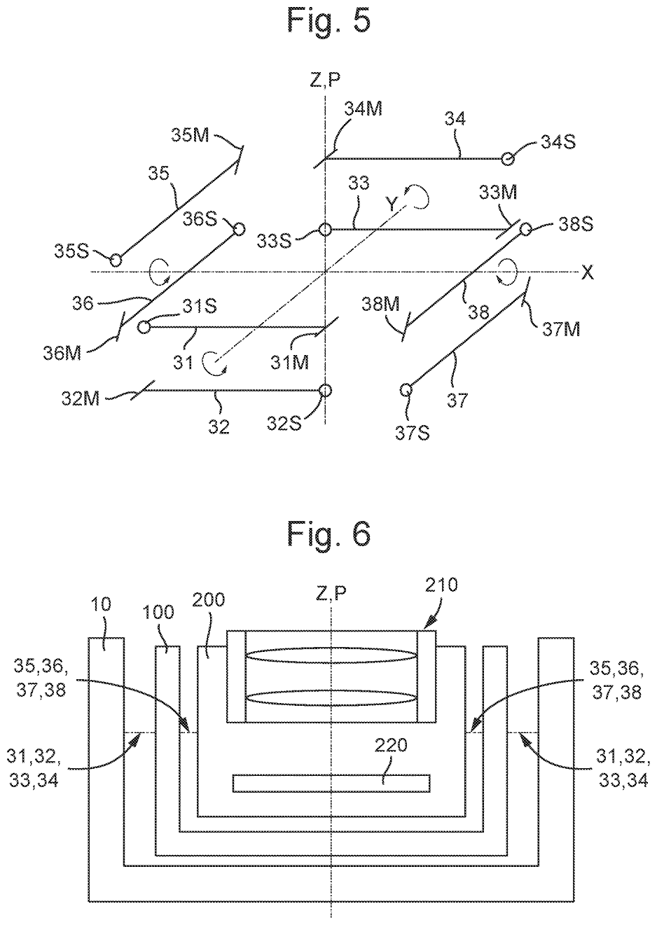

### FIG. 5

As illustrated in FIG. 5, further SMA actuating units 35-38 may be provided for e.g. rotating the second part 100 relative to the first 10 around the second axis X.

Optionally, as illustrated in FIG. 5, the second axis X extends through third and fourth sides of the second part 100; the bearing arrangement allows the second part 100 to rotate relative to the first part 10 about the second axis X, and allows the second part 100 to move relative to the first part 10 at least partly along the first axis Y and/or to rotate relative to the first part about the first primary axis Z; and the actuator assembly further comprises: fifth and sixth SMA actuating units 35, 36 configured to apply respective fifth and sixth forces to the third side of the second part 100; and seventh and eighth SMA actuating units 37, 38 configured to apply respective seventh and eighth forces to the fourth side of the second part 100; wherein the fifth and sixth forces are capable of rotating the second part 100 relative to the first part 10 in a first sense about the second axis X, the seventh and eighth forces are capable of rotating the second part 100 relative to the first part 10 in a second, opposite sense about the second axis X, each of the fifth and seventh forces has a (force) component in a first direction along a first axis Y, and each of the sixth and eighth forces has a (force) component in a second, opposite direction along the first axis Y.

The fifth and sixth forces may each and/or together be capable of rotating the second part 100 relative to the first part 10 in the first sense about the second axis X. The seventh and eighth forces may each and/or together be capable of rotating the second part 100 relative to the first part 10 in the second, opposite sense about the second axis X.

As shown in FIG. 5, each of the fifth, sixth, seventh and eighth SMA actuating units 35, 36, 37, 38 may comprise an SMA element 35, 36, 37, 38 (configured to contract when actuated, i.e. heated by passing an electric current through the SMA element) which is fixed to the first part 10 at a first end 35S, 36S, 37S, 38S and fixed to the second part 100 at a second end 35M, 36M, 37M, 38M.

Optionally, each of the fifth, sixth, seventh and/or eighth forces is substantially parallel to the first axis Y.

Optionally, each of the fifth, sixth, seventh and/or eighth forces has a (force) component in a first direction (i.e. in the same direction) along the first primary axis Z. The first direction mentioned above in relation to the first, second, third and/or fourth forces may correspond to this first direction.

Optionally, the (force) component(s) in the first direction along the first primary axis Z load the bearing arrangement (e.g. throughout the range of movement of the second part 100 relative to the first part 10).

Optionally, the fifth and sixth forces are applied at respective fifth and sixth points on the third side, and wherein the fifth and sixth points have substantially the same position along the first axis Y as the point at which the second axis X crosses the third side.

Optionally, the seventh and eighth forces are applied at respective seventh and eighth points on the fourth side, and wherein the seventh and eighth points have substantially the same position along the first axis Y as the point at which the second axis X crosses the fourth side.

Optionally, the points at which the fifth and sixth forces are applied to the second part 100 remain equally spaced from the second axis X throughout the range of rotational movement of the second part 100 relative to the first part 10 (i.e. the range of rotational movement the second part 100 is configured to be moved within relative to the first part 10 by the SMA actuating units).

Optionally, the points at which the seventh and eighth forces are applied to the second part 100 remain equally spaced from the second axis X throughout the range of rotational movement of the second part 100 relative to the first part 10 (i.e. the range of rotational movement the second part 100 is configured to be moved within relative to the first part 10 by the SMA actuating units).

Optionally, the distances between the second axis X and the points at which the fifth and sixth forces are applied to the second part 100 remain substantially constant throughout the range of rotational movement of the second part 100 relative to the first part 10 (i.e. the range of rotational movement the second part 100 is configured to be moved within relative the first part 10 by the SMA actuating units). Thus, the amount of rotation per unit actuation remains substantially constant and so the actuating units can be more effectively controlled.

Optionally, the distances between the second axis X and the points at which the seventh and eighth forces are applied to the second part 100 remain substantially constant throughout the range of rotational movement of the second part 100 relative to the first part 10 (i.e. the range of rotational movement the second part 100 is configured to be moved within relative the first part 10 by the SMA actuating units). Thus, the amount of rotation per unit actuation remains substantially constant and so the actuating units can be more effectively controlled.

The above-mentioned ‘range of rotational movement’ may refer to the range of rotation that the second part 100 is configured to rotate within, relative to the first part 10, about the second axis X and, optionally, about the first primary axis Z.

Optionally, the bearing arrangement comprises a third bearing element (not shown) positioned on (i.e. on or near to) the third side of the second part 100 and a fourth bearing element (not shown) positioned on (i.e. on or near to) the fourth side of the second part 100.

Optionally, each third and fourth bearing element is a rolling element (e.g. a ball bearing) which interacts with bearing surfaces associated with the second part 100 and an intermediate part (herein also referred to as a ‘gimbal component’) (not shown) so as to guide the rotation of the second part 100 relative to the first part 10 about the second axis X and to guide the movement of the second part 100 relative to the first part 10 at least partly along the first axis Y and/or the rotation of the second part 100 relative to the first part 10 about the first primary axis Z.

Optionally, the SMA actuating units 31-38 each comprise one or more SMA elements.

Optionally, the actuator assembly comprises only two SMA actuating units (i.e. the fifth and sixth SMA actuating units 35, 36) applying forces to the third side of the second part 100, and only two SMA actuating units (i.e. the seventh and eighth SMA actuating units 37, 38) applying forces to the fourth side of the second part 100.

Optionally, the fifth, sixth, seventh and eighth SMA actuating units 35-38 are configured, on selective actuation, to rotate (e.g. in both senses) the second part 100 relative to the first part 10 about the first primary axis Z.

Optionally, the fifth, sixth, seventh and eighth SMA actuating units 35-38 are configured, on selective actuation, to move the second part 100 relative to the first part 10 at least partly along the first axis Y.

### FIG. 6

Instead of having the fifth, sixth, seventh and eighth SMA actuating units 35-38 arranged between the first part 10 and the second part 100, as illustrated in FIG. 5, the fifth, sixth, seventh and eighth SMA actuating units 35-38 may be arranged between a third part 200 and the second part 100 as illustrated in FIG. 6.

As illustrated in FIG. 6, the actuator assembly may comprise: a third part 200 that is movable relative to the second part 100, with a third axis that is perpendicular to the second primary axis P and that extends through third and fourth sides of the third part, and a fourth axis that is perpendicular to the second primary axis P and the third axis; a second bearing arrangement that allows the third part 200 to rotate relative to the second part 100 about the third axis and that further allows the third part 200 to move relative to the second part 100 at least partly along the fourth axis and/or to rotate relative to the third part 200 about the second primary axis P; and fifth and sixth SMA actuating units 35, 36 configured to apply respective fifth and sixth forces to the third side of the third part 200; and seventh and eighth SMA actuating units 37, 38 configured to apply respective seventh and eighth forces to the fourth side of the third part 200; wherein the fifth and sixth forces are capable of rotating the third part 200 relative to the second part 100 in a first sense about the third axis, the seventh and eighth forces are capable of rotating the third part 200 relative to the second part 100 in a second, opposite sense about the third axis, each of the fifth and seventh forces has a (force) component in a first direction along a fourth axis, and each of the sixth and eighth forces has a (force) component in a second, opposite direction along the fourth axis.

The fifth and sixth forces may each and/or together be capable of rotating the third part 200 relative to the second part 100 in the first sense about the third axis. The seventh and eighth forces may each and/or together be capable of rotating the third part 200 relative to the second part 100 in the second, opposite sense about the third axis.

Where this is the case, each of the fifth, sixth, seventh and eighth SMA actuating units 35-38 may comprise an SMA element 35-38 (configured to contract when actuated, i.e. heated by passing an electric current through the SMA element) which is fixed to the second part 100 at a first end 35S, 36S, 37S, 38S and fixed to the third part 200 at a second end 35M, 36M, 37M, 38M, as illustrated in FIG. 6.

The third part 200 may comprise an image sensor 220 and a lens assembly 210 for focusing an image onto the image sensor 220.

Optionally, each of the fifth, sixth, seventh and/or eighth forces is substantially parallel to the fourth axis.

Optionally, each of the fifth, sixth, seventh and/or eighth forces has a (force) component in a first direction (i.e. in the same direction) along the second primary axis P. The first direction along the second primary axis P may be co-directional with, or opposite to, the first direction along the first primary axis Z mentioned above in relation to the first, second, third and/or fourth forces when the first and second primary axis Z, P are aligned as illustrated in FIG. 6.

When the first and second primary axis Z, P are aligned, as illustrated in FIG. 6, the third axis may be parallel with the second axis X, and the fourth axis may be parallel with the first axis Y.

Optionally, the (force) component(s) in the first direction along the second primary axis P load the second bearing arrangement.

Optionally, the fifth and sixth forces are applied at respective fifth and sixth points on the third side, and wherein the fifth and sixth points have substantially the same position along the fourth axis as the point at which the third axis crosses the third side.

Optionally, the seventh and eighth forces are applied at respective seventh and eighth points on the fourth side, and wherein the seventh and eighth points have substantially the same position along the fourth axis as the point at which the third axis crosses the fourth side.

Optionally, the points at which the fifth and sixth forces are applied to the third part 200 remain equally spaced from the third axis throughout the range of rotational movement of the third part 200 relative to the second part 100 (i.e. the range of rotational movement the third part 200 is configured to be moved within relative the second part 100).

Optionally, the points at which the seventh and eighth forces are applied to the third part 200 remain equally spaced from the third axis throughout the range of rotational movement of the third part 200 relative to the second part 100 (i.e. the range of rotational movement the third part 200 is configured to be moved within relative the second part 100).

Optionally, the distances between the third axis and the points at which the fifth and sixth forces are applied to the third part 200 remain substantially constant throughout the range of rotational movement of the third part 200 relative to the second part 100 (i.e. the range of rotational movement the third part 200 is configured to be moved within relative the second part 100). Thus, the amount of rotation per unit actuation remains substantially constant and so the actuating units can be more effectively controlled.

Optionally, the distances between the third axis and the points at which the seventh and eighth forces are applied to the third part 200 remain substantially constant throughout the range of rotational movement of the third part 200 relative to the second part 100 (i.e. the range of rotational movement the third part 200 is configured to be moved within relative the second part 100). Thus, the amount of rotation per unit actuation remains substantially constant and so the actuating units can be more effectively controlled.

The above-mentioned ‘range of rotational movement of the third part 200’ may refer to the range of rotation that the third part 200 is configured to rotate within, relative to the second part 100, about the third axis and, optionally, about the second primary axis P.

Optionally, the second bearing arrangement (not shown) comprises a third bearing element positioned on (i.e. on or near to) the third side of the third part 200 and a fourth bearing element positioned on (i.e. on or near to) the fourth side of the third part 200.

Optionally, each third and fourth bearing element is a rolling element (e.g. a ball bearing) which interacts with bearing surfaces associated with the second and third parts 100, 200 so as to guide the rotation of the third part 200 relative to the second part 100 about the third axis and to guide the movement of the third part 200 relative to the second part 100 at least partly along the fourth axis and/or the rotation of the third part 200 relative to the second part 100 about the second primary axis P.

Optionally, the SMA actuating units 35-38 each comprise one or more SMA elements.

Optionally, the actuator assembly comprises only two SMA actuating units (i.e. the fifth and sixth SMA actuating units 35, 36) applying forces to the third side of the third part 200, and only two SMA actuating units (i.e. the seventh and eighth SMA actuating units 37, 38) applying forces to the fourth side of the third part 200.

Optionally, the fifth, sixth, seventh and eighth SMA actuating units 35-38 are configured, on selective actuation, to rotate (e.g. in both senses) the third part 200 relative to the second part 100 about the second primary axis P.

Optionally, the fifth, sixth, seventh and eighth SMA actuating units 35-38 are configured, on selective actuation, to move the third part 200 relative to the second part 100 at least partly along the fourth axis.

Optionally, the first and third axes are non-parallel.

Optionally, the first, second, third and fourth sides are arranged in a loop around the first primary axis Z. The first and second sides may be opposite sides. The third and fourth sides may be opposite sides.

### Method of Controlling the Actuator Assembly

The actuator assemblies mentioned above may be controlled by using a method comprising: actuating the first, second, third and/or fourth actuating units 31-34 so as to cause the second part 100 to rotate relative to the first part 10 about the first axis Y, while controlling the position of the second part 100 relative to the first part 10 along the second axis X and/or the rotation of the second part 100 relative to the first part 10 about the first primary axis Z.

Optionally, the method comprises actuating the first, second, third and/or fourth actuating units 31-34 so as to cause the second part 100 to rotate relative to the first part 10 about the first primary axis Z.

Optionally, the method comprises actuating the fifth, sixth, seventh and/or eighth actuating units 35-38 (of e.g. FIG. 5) so as to cause the second part 100 to rotate relative to the first part 10 about the second axis X, while controlling the position of the second part 100 relative to the first part 10 along the first axis Y and/or the rotation of the second part 100 relative to the first part 10 about the first primary axis Z.

Optionally, the method comprises actuating the fifth, sixth, seventh and/or eighth actuating units 35-38 (of e.g. FIG. 5) so as to cause the second part 100 to rotate relative to the first part 10 about the first primary axis Z.

Optionally, the method comprises actuating the fifth, sixth, seventh and/or eighth actuating units 35-38 (of e.g. FIG. 6) so as to cause the third part 200 to rotate relative to the second part 100 about the third axis, while controlling the position of the third part 200 relative to the second part 100 along the fourth axis and/or the rotation of the third part 200 relative to the second part 100 about the second primary axis P.

Optionally, the method comprises actuating the fifth, sixth, seventh and/or eighth actuating units 35-38 (of e.g. FIG. 6) so as to cause the third part 200 to rotate relative to the second part 100 about the second primary axis P.

### Further Description of the Illustrated Embodiments

Each of the above-mentioned actuator assemblies may also be described as an actuator assembly comprising: a first part 10, with a first primary axis Z defined with reference to the first part 10; a second part 100 that is movable relative to the first part 10, with a second primary axis P defined with reference to the second part 100; a first pair of SMA actuating units (i.e. the first and second SMA actuating units 31, 32) configured to apply a torque to a first side of the second part 100 to drive rotation/tilting of the second part 100 relative to the first part 10 in a first sense about a first tilt axis Y (also referred to as ‘first axis Y’ herein), wherein the first tilt axis Y is perpendicular to the first primary axis Z; a second pair of SMA actuating units (i.e. the third and fourth SMA actuating units 33, 34) configured to apply a torque to a second side of the second part 100 to drive rotation/tilting of the second part 100 relative to the first part 10 in a second, opposite sense about the first tilt axis Y; wherein the first and second sides are opposite sides through which the first tilt axis Y extends; wherein only the first pair of SMA actuating units 31, 32 are configured to apply a torque to the first side for rotating the second part 100 relative to the first part 10 about the first tilt axis Y, and only the second pair of actuating units 33, 34 are configured to apply a torque to the second side for rotating the second part 100 relative to the first part 10 about the first tilt axis Y; wherein each SMA actuating unit 31-34 is configured to apply a force to the second part 100 in a direction perpendicular to the first primary axis Z, or configured to apply a force with a force component in a first direction (i.e. in the same direction) parallel to the first primary axis Z (e.g. throughout the range of movement of the second part 100 relative to the first part 10).

Optionally, as illustrated in FIGS. 2-4, the actuator assembly comprises a first bearing arrangement 41, 42 configured to allow tilting/rotation of the second part 100 relative to the first part 10 about the first tilt axis Y, and to constrain tilting/rotation of the second part 100 relative to the first part 10 about an axis (e.g. the second tilt axis mentioned hereinafter, or an axis parallel to said second tilt axis) which is non-parallel to the first tilt axis Y and is perpendicular to the first primary axis Z.

Optionally, as illustrated in FIG. 6, the actuator assembly comprises: a third part 200 movable relative to the second part 100; a third plurality of SMA actuating units (e.g. the fifth and sixth SMA actuating units 35, 36) each configured to apply a torque to a third side of the third part 200 to drive rotation of the third part 200 relative to the second part 100 about a second tilt axis (also referred to as ‘third axis’ herein) in a first sense, wherein the second tilt axis is non-parallel to the first tilt axis Y and is perpendicular to the second primary axis P; a fourth plurality of SMA actuating units (e.g. the seventh and eighth SMA actuating units 37, 38) each configured to apply a torque to a fourth side of the third part 200 to drive rotation of the third part 200 relative to the second part 100 about the second tilt axis in a second, opposite sense; and wherein the third and fourth sides are opposite sides through which the second tilt axis extends.

Optionally, the actuator assembly comprises a second bearing arrangement (not shown) configured to allow tilting/rotation of the third part 200 relative to the second part 100 about the second tilt axis, and to constrain tilting/rotation of the third part 200 relative to the second part 100 about the first tilt axis Y or an axis parallel to the first tilt axis Y.

Optionally, only the third plurality of SMA actuating units 35, 36 are configured to apply a torque to the third part 200 for rotating the third part 200 relative to the second part 100 about the second tilt axis; and only the fourth plurality of SMA actuating units 37, 38 are configured to apply a torque to the third part 200 for rotating the third part 200 relative to the second part 100 about the second tilt axis.

Optionally, each SMA actuating unit of the third and fourth plurality of SMA actuating units 35-38 is configured to apply a force to the third part 200 in a direction perpendicular to the second primary axis P, or configured to apply a force to the third part 200 with a force component in a first direction (i.e. in the same direction) parallel to the second primary axis P (e.g. throughout the range of movement of the third part 200 relative to the second part 100).

Optionally, as illustrated in FIG. 5, the actuator assembly comprises: a third plurality of SMA actuating units (e.g. the fifth and sixth SMA actuating units 35, 36) each configured to apply a torque to a third side of the second part 100 to drive rotation of the second part 100 relative to the first part 10 about a second tilt axis X (also referred to as ‘second axis X’ herein) in a first sense, wherein the second tilt axis X is non-parallel to the first tilt axis Y and is perpendicular to the first primary axis Z; a fourth plurality of SMA actuating units (e.g. the seventh and eighth SMA actuating units 37, 38) each configured to apply a torque to a fourth side of the second part 100 to drive rotation of the second part 100 relative to the first part 10 about the second tilt axis X in a second, opposite sense; and wherein the third and fourth sides are opposite sides through which the second tilt axis X extends.

Optionally, the actuator assembly comprises a bearing arrangement configured to allow tilting/rotation of the second part 100 relative to the first part 10 about the first and second tilt axes Y, X.

Optionally, only the third plurality of SMA actuating units 35, 36 are configured to apply a torque to the second part 100 for rotating the second part 100 relative to the first part 10 about the second tilt axis X; and only the fourth plurality of SMA actuating units 37, 38 are configured to apply a torque to the second part 100 for rotating the second part 100 relative to the first part 10 about the second tilt axis X.

Optionally, each SMA actuating unit of the third and fourth plurality of SMA actuating units 35-38 is configured to apply a force to the second part 100 in a direction perpendicular to the first primary axis Z, or configured to apply a force to the second part 100 with a force component in a first direction parallel to the first primary axis Z (e.g. throughout the range of movement of the second part 100 relative to the first part 10).

Optionally, the third plurality of SMA actuating units 35, 36 comprises a total of two SMA actuating units and the fourth plurality of SMA actuating units 37, 38 comprises a total of two SMA actuating units.

Optionally, the forces applied by the first pair of SMA actuating units 31, 32 are above and below the first tilt axis Y as viewed along the first tilt axis Y.

Optionally, the forces applied by the second pair of SMA actuating units 33, 34 are above and below the first tilt axis Y as viewed along the first tilt axis Y.

Optionally, the axes in which the forces applied by the first pair of SMA actuating units 31, 32 lie are non-intersecting (do not cross one another) within the footprint of the actuator assembly as viewed along the first tilt axis Y.

Optionally, the axes in which the forces applied by the second pair of SMA actuating units 33, 34 lie are non-intersecting (do not cross one another) within the footprint of the actuator assembly as viewed along the first tilt axis Y.

Optionally, the SMA elements comprising part of the first pair of SMA actuating units 31, 32 are non-intersecting (do not cross one another) as viewed along the first tilt axis Y.

Optionally, the SMA elements comprising part of the second pair of SMA actuating units 33, 34 are non-intersecting (do not cross one another) as viewed along the first tilt axis Y.

Optionally, the forces applied by the third plurality of SMA actuating units 35, 36 are above and below the second tilt axis X as viewed along the second tilt axis X.

Optionally, the forces applied by the fourth plurality of SMA actuating units 37, 38 are above and below the second tilt axis X as viewed along the second tilt axes X.

Optionally, the axes in which the forces applied by the third plurality of SMA actuating units 35, 36 lie are non-intersecting (do not cross one another) within the footprint of the actuator assembly as viewed along the second tilt axis X.

Optionally, the axes in which the forces applied by the fourth plurality of SMA actuating units 37, 38 lie are non-intersecting (do not cross one another) within the footprint of the actuator assembly as viewed along the second tilt axis X.

Optionally, the SMA elements comprising part of the third plurality of SMA actuating units 35, 36 are non-intersecting (do not cross one another) as viewed along the second tilt axis X.

Optionally, the SMA elements comprising part of the fourth plurality of SMA actuating units 37, 38 are non-intersecting (do not cross one another) as viewed along the second tilt axis X.

### Other Variations

It will be appreciated that there may be many other variations of the above-described examples.

### SMA

The above-described SMA actuator assemblies comprise at least one SMA element. The term ‘shape memory alloy (SMA) element’ may refer to any element comprising SMA. The SMA element may be described as an SMA wire. The SMA element may have any shape that is suitable for the purposes described herein. The SMA element may be elongate and may have a round cross section or any other shape cross section. The cross section may vary along the length of the SMA element. The SMA element might have a relatively complex shape such as a helical spring. It is also possible that the length of the SMA element (however defined) may be similar to one or more of its other dimensions. The SMA element may be sheet-like, and such a sheet may be planar or non-planar. The SMA element may be pliant or, in other words, flexible. In some examples, when connected in a straight line between two components, the SMA element can apply only a tensile force which urges the two components together. In other examples, the SMA element may be bent around a component and can apply a force to the component as the SMA element tends to straighten under tension. The SMA element may be beam-like or rigid and may be able to apply different (e.g. non-tensile) forces to elements. The SMA element may or may not include material(s) and/or component(s) that are not SMA. For example, the SMA element may comprise a core of SMA and a coating of non-SMA material. Unless the context requires otherwise, the term ‘SMA element’ may refer to any configuration of SMA material acting as a single actuating element which, for example, can be individually controlled to produce a force on an element. For example, the SMA element may comprise two or more portions of SMA material that are arranged mechanically in parallel and/or in series. In some arrangements, the SMA element may be part of a larger SMA element. Such a larger SMA element might comprise two or more parts that are individually controllable, thereby forming two or more SMA elements. The SMA element may comprise an SMA wire, SMA foil, SMA film or any other configuration of SMA material. The SMA element may be manufactured using any suitable method, for example by a method involving drawing, rolling, deposition, sintering or powder fusion. The SMA element may exhibit any shape memory effect, e.g. a thermal shape memory effect or a magnetic shape memory effect, and may be controlled in any suitable way, e.g. by Joule heating, another heating technique or by applying a magnetic field.

1. An actuator assembly comprising:
a first part, with a first primary axis defined with reference to the first part;
a second part that is movable relative to the first part, with a second primary axis defined with reference to the second part, a first axis that is perpendicular to the first primary axis and that extends through first and second sides of the second part, and a second axis that is perpendicular to the first primary axis and the first axis;
a bearing arrangement that allows the second part to rotate relative to the first part about the first axis and that further allows the second part to move relative to the first part at least partly along the second axis and/or to rotate relative to the first part about the first primary axis; and
first and second SMA (shape memory alloy) actuating units configured to apply respective first and second forces to the first side of the second part; and
third and fourth SMA actuating units configured to apply respective third and fourth forces to the second side of the second part;
wherein the first and second forces are capable of rotating the second part relative to the first part in a first sense about the first axis, the third and fourth forces are capable of rotating the second part relative to the first part in a second, opposite sense about the first axis, each of the first and third forces has a component in a first direction along a second axis, and each of the second and fourth forces has a component in a second, opposite direction along the second axis.

2. An actuator assembly according to claim 1, wherein each of the first, second, third and/or fourth forces is substantially parallel to the second axis; or
wherein each of the first, second, third and/or fourth forces has a component in a first direction along the first primary axis, the component(s) in the first direction along the first primary axis loading the bearing arrangement.

3. (canceled)

4. (canceled)

5. An actuator assembly according to claim 1, wherein the first and second forces are applied at respective first and second points on the first side, and wherein the first and second points have substantially the same position along the second axis as the point at which the first axis crosses the first side.

6. An actuator assembly according to claim 1, wherein the third and fourth forces are applied at respective third and fourth points on the second side, and wherein the third and fourth points have substantially the same position along the second axis as the point at which the first axis crosses the second side.

7. An actuator assembly according to claim 1, wherein the points at which the first and second forces are applied to the second part remain equally spaced from the first axis throughout the range of rotational movement of the second part relative to the first part; or
wherein the points at which the third and fourth forces are applied to the second part remain equally spaced from the first axis throughout the range of rotational movement of the second part relative to the first part.

8. (canceled)

9. An actuator assembly according to claim 1, wherein the distances between the first axis and the points at which the first and second forces are applied to the second part remain substantially constant throughout the range of rotational movement of the second part relative to the first part; or
wherein the distances between the first axis and the points at which the third and fourth forces are applied to the second part remain substantially constant throughout the range of rotational movement of the second part relative to the first part.

10. (canceled)

11. An actuator assembly according to claim 1, wherein the bearing arrangement comprises a first bearing element positioned on the first side of the second part and a second bearing element positioned on the second side of the second part.

12. An actuator assembly according to claim 11, wherein each bearing element is a rolling element which interacts with bearing surfaces associated with the first and second parts so as to guide the rotation of the second part relative to the first part about the first axis and to guide the movement of the second part relative to the first part at least partly along the second axis and/or the rotation of the second part relative to the first part about the first primary axis.

13. An actuator assembly according to claim 1, wherein the SMA actuating units each comprise one or more SMA elements;
wherein the actuator assembly comprises only two SMA actuating units applying forces to the first side of the second part, and only two SMA actuating units applying forces to the second side of the second part; and
wherein the first, second, third and fourth SMA actuating units are configured, on selective actuation, to:
rotate the second part relative to the first part about the first primary axis; or
move the second part relative to the first part at least partly along the second axis.

14. (canceled)

15. (canceled)

16. (canceled)

17. An actuator assembly according to claim 1, wherein:
the second axis extends through third and fourth sides of the second part;
the bearing arrangement allows the second part to rotate relative to the first part about the second axis, and allows the second part to move relative to the first part at least partly along the first axis and/or to rotate relative to the first part about the first primary axis; and the actuator assembly further comprises:
fifth and sixth SMA actuating units configured to apply respective fifth and sixth forces to the third side of the second part; and
seventh and eighth SMA actuating units configured to apply respective seventh and eighth forces to the fourth side of the second part;
wherein the fifth and sixth forces are capable of rotating the second part relative to the first part in a first sense about the second axis, the seventh and eighth forces are capable of rotating the second part relative to the first part in a second, opposite sense about the second axis, each of the fifth and seventh forces has a component in a first direction along the first axis, and each of the sixth and eighth forces has a component in a second, opposite direction along the first axis.

18. An actuator assembly according to claim 1, comprising:
a third part that is movable relative to the second part, with a third axis that is perpendicular to the second primary axis and that extends through third and fourth sides of the third part, and a fourth axis that is perpendicular to the second primary axis and the third axis;
a second bearing arrangement that allows the third part to rotate relative to the second part about the third axis and that further allows the third part to move relative to the second part at least partly along the fourth axis and/or to rotate relative to the third part about the second primary axis; and
fifth and sixth SMA actuating units configured to apply respective fifth and sixth forces to the third side of the third part; and
seventh and eighth SMA actuating units configured to apply respective seventh and eighth forces to the fourth side of the third part;
wherein the fifth and sixth forces are capable of rotating the third part relative to the second part in a first sense about the third axis, the seventh and eighth forces are capable of rotating the third part relative to the second part in a second, opposite sense about the third axis, each of the fifth and seventh forces has a component in a first direction along a fourth axis, and each of the sixth and eighth forces has a component in a second, opposite direction along the fourth axis.

19. An actuator assembly according to claim 18, wherein the first and third axes are non-parallel.

20. An actuator assembly according to claim 19, wherein the first, second, third and fourth sides are arranged in a loop around the first primary axis.

21. A method of controlling an actuator assembly according to claim 1, the method comprising:
actuating the first, second, third and/or fourth actuating units so as to cause the second part to rotate relative to the first part about the first axis, while controlling the position of the second part relative to the first part along the second axis and/or the rotation of the second part relative to the first part about the first primary axis.

22. A method according to claim 21, further comprising actuating the first, second, third and/or fourth actuating units so as to cause the second part to rotate relative to the first part about the first primary axis.

23. A method according to claim 21, wherein:
the second axis extends through third and fourth sides of the second part;
the bearing arrangement allows the second part to rotate relative to the first part about the second axis, and allows the second part to move relative to the first part at least partly along the first axis and/or to rotate relative to the first part about the first primary axis; and the actuator assembly further comprises:
fifth and sixth SMA actuating units configured to apply respective fifth and sixth forces to the third side of the second part; and
seventh and eighth SMA actuating units configured to apply respective seventh and eighth forces to the fourth side of the second part;
wherein the fifth and sixth forces are capable of rotating the second part relative to the first part in a first sense about the second axis, the seventh and eighth forces are capable of rotating the second part relative to the first part in a second, opposite sense about the second axis, each of the fifth and seventh forces has a component in a first direction along the first axis, and each of the sixth and eighth forces has a component in a second, opposite direction along the first axis; and
wherein the method further comprises actuating the fifth, sixth, seventh and/or eighth actuating units so as to cause the second part to rotate relative to the first part about the second axis, while controlling the position of the second part relative to the first part along the first axis and/or the rotation of the second part relative to the first part about the first primary axis.

24. A method according to claim 23, further comprising actuating the fifth, sixth, seventh and/or eighth actuating units so as to cause the second part to rotate relative to the first part about the first primary axis.

25. A method according to claim 21, wherein the actuator assembly further comprises:
a third part that is movable relative to the second part, with a third axis that is perpendicular to the second primary axis and that extends through third and fourth sides of the third part, and a fourth axis that is perpendicular to the second primary axis and the third axis;
a second bearing arrangement that allows the third part to rotate relative to the second part about the third axis and that further allows the third part to move relative to the second part at least partly along the fourth axis and/or to rotate relative to the third part about the second primary axis; and
fifth and sixth SMA actuating units configured to apply respective fifth and sixth forces to the third side of the third part; and
seventh and eighth SMA actuating units configured to apply respective seventh and eighth forces to the fourth side of the third part;
wherein the fifth and sixth forces are capable of rotating the third part relative to the second part in a first sense about the third axis, the seventh and eighth forces are capable of rotating the third part relative to the second part in a second, opposite sense about the third axis, each of the fifth and seventh forces has a component in a first direction along a fourth axis, and each of the sixth and eighth forces has a component in a second, opposite direction along the fourth axis; and
wherein the method further comprises actuating the fifth, sixth, seventh and/or eighth actuating units so as to cause the third part to rotate relative to the second part about the third axis, while controlling the position of the third part relative to the second part along the fourth axis and/or the rotation of the third part relative to the second part about the second primary axis.

26. A method according to claim 25, further comprising actuating the fifth, sixth, seventh and/or eighth actuating units so as to cause the third part to rotate relative to the second part about the second primary axis.

27. An actuator assembly comprising:
a first part, with a first primary axis defined with reference to the first part;
a second part that is movable relative to the first part, with a second primary axis defined with reference to the second part;
a first pair of SMA actuating units configured to apply a torque to a first side of the second part to drive rotation of the second part relative to the first part in a first sense about a first tilt axis, wherein the first tilt axis is perpendicular to the first primary axis;
a second pair of SMA actuating units configured to apply a torque to a second side of the second part to drive rotation of the second part relative to the first part in a second, opposite sense about the first tilt axis;
wherein the first and second sides are opposite sides through which the first tilt axis extends;
wherein only the first pair of SMA actuating units are configured to apply a torque to the first side for rotating the second part relative to the first part about the first tilt axis, and only the second pair of actuating units are configured to apply a torque to the second side for rotating the second part relative to the first part about the first tilt axis;
wherein each SMA actuating unit is configured to apply a force to the second part in a direction perpendicular to the first primary axis, or configured to apply a force with a force component in a first direction parallel to the first primary axis.

28.-37. (canceled)
